(19) United States
(12) Patent Application Publication
(10) Pub. No.: US 2009/0018805 A1
(43) Pub. Date: Jan. 15, 2009

(54) Optically selective coatings for plant tissues

(76) Inventors: Michael Weber, Sunnyvale, CA (US); Ray Hoobler, Pleasanton, CA (US); David Cope, Los Gatos, CA (US); Patrick Gibbons, Yakima, WA (US)

Correspondence Address: CARR & FERRELL LLP, 2200 GENG ROAD, PALO ALTO, CA, 94303, US

(21) Appl. No.: 11/827,911

(22) Filed: Jul. 12, 2007

(51) Int. Cl. G06G 7/48; A01N 25/26

(52) U.S. Cl. 703/6; 504/116.1

(57) ABSTRACT

The present invention provides optically selective coatings for plant tissues, such as agricultural products. The coatings are designed to transmit a desired spectrum of light, while preventing harmful intensities of radiation in given wavelength ranges from damaging the plant tissues. For example, a coating may be tailored to perform as a low-pass filter preferentially allowing shorter wavelengths to penetrate the coating, a high-pass filter preferentially passing longer wavelengths, or a band-pass filter, preferentially passing visible light to the plant tissues while minimizing the penetration of ultraviolet and infrared light. An exemplary embodiment comprises making an optically selective coating by determining a desired transmission spectrum for the coating, then calculating the film properties (such as thickness, particle size, and/or index of refraction, for example) of one or more materials to obtain the desired transmission spectrum for the film to be applied to the surface to be protected.

### BACKGROUND OF THE INVENTION

1. Field of the Invention

This invention relates to protecting plant tissues from radiation damage, and more specifically to coatings for plant tissues.

2. Description of Related Art

Plants require visible light with wavelengths in the range of 400 to 700 nanometers for growth and photosynthesis. Electromagnetic radiation with wavelengths outside this range, such as ultraviolet and infrared sunlight, may damage plant tissues. Excessive infrared light, in particular, can bake fruit even before its removal from a tree. Such damage causes economic losses in industries that depend on healthy plant tissues, such as agricultural industries.

Currently practiced methods of protecting plant tissues from radiation damage include netting, water cooling, and coating with chemical or particle films. However, these methods are clumsy solutions for the problem of radiation damage: not only are they not finely tuned and thus less effective than is desired, but they also introduce other kinds of problems.

For example, netting trees to shade their fruit is expensive, and interferes with access to the fruit for pre-harvest spraying as well as for harvesting. Also, since nets do not block radiation in a wavelength-selective manner, netted fruits are shaded from beneficial light as well as harmful radiation. Thus, fruits grown under netting tend to be smaller. Also, fruit that is exposed suddenly to high-intensity sunlight (for example, when netting is removed or the leafy parts of the tree are trimmed) can acquire undesirable sunburn.

In the tree fruit industry, growers typically turn on overhead cooling sprinklers when the temperature rises above 85° F. It is common to leave the cooling water on until the temperature drops below 80° F. Often, this means that cooling sprinklers are used from the end of June through mid-September. For example, on average a grower in the Yakima, Wash. area cools his orchard in this manner for 250 hours per season, at a rate of 50 gallons per acre per minute, or 750,000 gallons of water per acre for a season for cooling. Not only is this approach costly and wasteful of water, but it has many other drawbacks: it requires the installation and operation of overhead showering equipment, washes applied chemicals off of the plant tissues, can cause water damage such as stem-end splitting, russetting, and mildew in the canopy, and can spread microbes from contaminated fruits onto the orchard floor.

While chemical coating of plant tissues can overcome some of the drawbacks of netting and wetting, chemical sunshields are still a crude approach to protecting plant tissues from radiation damage. Current products used for protecting fruit from solar radiation include naturally occurring materials such as kaolin, limestone, and carnauba wax. Kaolin and limestone act as diffuse reflectors, while carnauba wax has characteristic absorption properties. These sunshields generally do not allow desired wavelengths preferentially to reach the agricultural products while blocking other wavelengths.

Chemical coatings containing large particles (of about 10-100 microns) can be difficult to apply. Special spraying equipment may be required to place these particles at the tops of trees, where they are needed most; in addition, the particles may abrade the pumps and spray nozzles used for application, and may tend to settle out of solution and/or flock into even larger particles. After harvest, it may be difficult to remove the chemical coatings, which are no longer needed or desired.

Coatings of microscopic particles that simply block radiation by barring the sun's rays, as a larger-scale net does, block beneficial radiation as well as harmful radiation from reaching the plant tissues where a particle rests, and allow harmful radiation along with beneficial radiation to reach the tissues where no particle is sitting. These coatings are analogous to covering one's skin with postage stamps before sunbathing: under the stamps, the skin would remain pale, but between the stamps, it could become sunburned. When chemical coatings block beneficial wavelengths of light, delayed ripening, smaller size, and poor coloration of fruit may result.

FIG. 1 is a graph of the transmission of electromagnetic radiation as a function of wavelength (in nanometers) for a chemical coating product consisting of particles. This product has a very flat transmission spectrum; twenty-five to thirty percent of light at all wavelengths from the ultraviolet to the infrared are transmitted through the coating. The flatness of the curve is an indication that particles in the coating simply block transmission. Thus, the coating fails to provide desired optical characteristics, such as low transmission of infrared light.

FIG. 2 is a bar graph showing the sun-protection factor (“SPF”) of a large-particle chemical coating product. The bars represent averages of the transmission over the wavelength ranges indicated. The SPF is the reciprocal of the percent transmission. For example, an SPF of 15 represents 6.7 percent transmission of radiation having a given wavelength, or equivalently, blocking 93.3 percent of the light for a given wavelength or wavelength range. The leftmost bar shows the averaged percent transmission over the ultraviolet wavelength range (of 360-420 nm); the middle bar shows the averaged percent transmission over visible wavelengths (of 420-575 nm), and the rightmost bar shows the averaged percent transmission over the near infrared wavelengths (of 575-830 nm). The SPF of this chemical coating product is similarly low at all wavelengths, indicating the coating's low sun-protection ability, particularly in the infrared.

While it is possible further to reduce transmission of wavelengths in the damaging parts of the spectrum by the application of multiple coats of particle film, this is more costly. Even more importantly, multiple applications further block out the light in the visible wavelength range that is necessary for photosynthesis and fruit development.

What is desired is a chemical coating or set of coatings that can protect plant tissues from electromagnetic radiation in a highly wavelength-dependent manner.

### SUMMARY OF THE INVENTION

The present invention provides optically selective coatings for plant tissues, such as agricultural products. The coatings are designed to transmit a desired spectrum of light, while preventing harmful intensities of radiation in given wavelength ranges from damaging the plant tissues. For example, a coating may be tailored to perform as a low-pass filter preferentially allowing shorter wavelengths to penetrate the coating, a high-pass filter preferentially passing longer wavelengths, or a band-pass filter, preferentially passing visible light to the plant tissues while minimizing the penetration of ultraviolet and infrared light. An exemplary embodiment comprises making an optically selective coating by determining a desired transmission spectrum for the coating, then calculating the film properties (such as thickness, particle size, and/or index of refraction, for example) of one or more materials to obtain the desired transmission spectrum for the film to be applied to the surface to be protected.

### BRIEF DESCRIPTION OF THE DRAWINGS

FIG. 1 is a graph of the transmission of electromagnetic radiation as a function of wavelength for a chemical coating product consisting of particles.

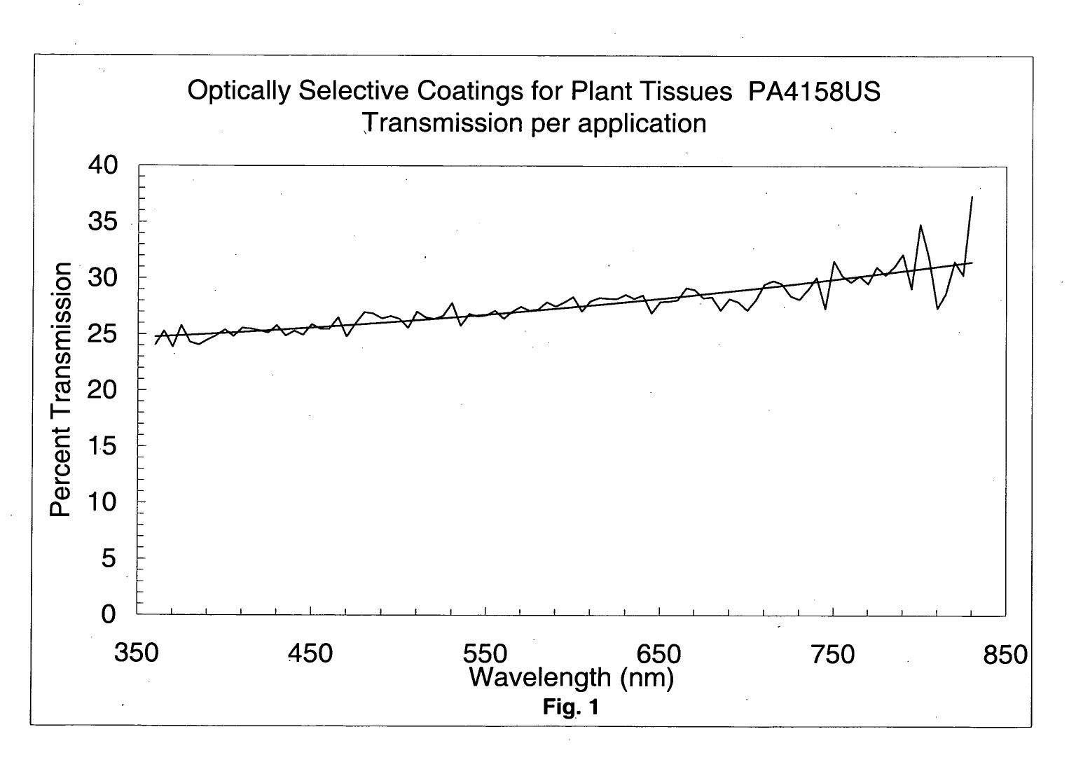

FIG. 2 is a bar graph showing the sun-protection factor of a large-particle chemical coating product.

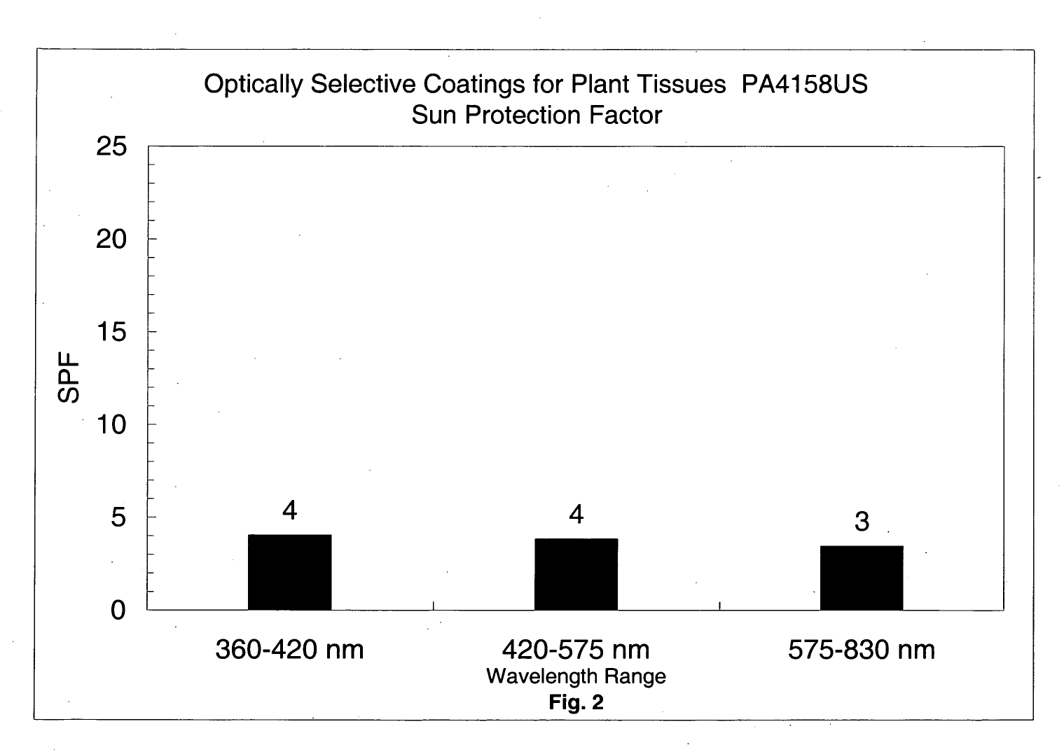

FIG. 3 shows exemplary transmission spectra for exemplary optically selective coatings.

FIG. 4 is a flow chart of a method for producing an optically selective coating tailored for use on a particular plant tissue.

### DETAILED DESCRIPTION OF THE INVENTION

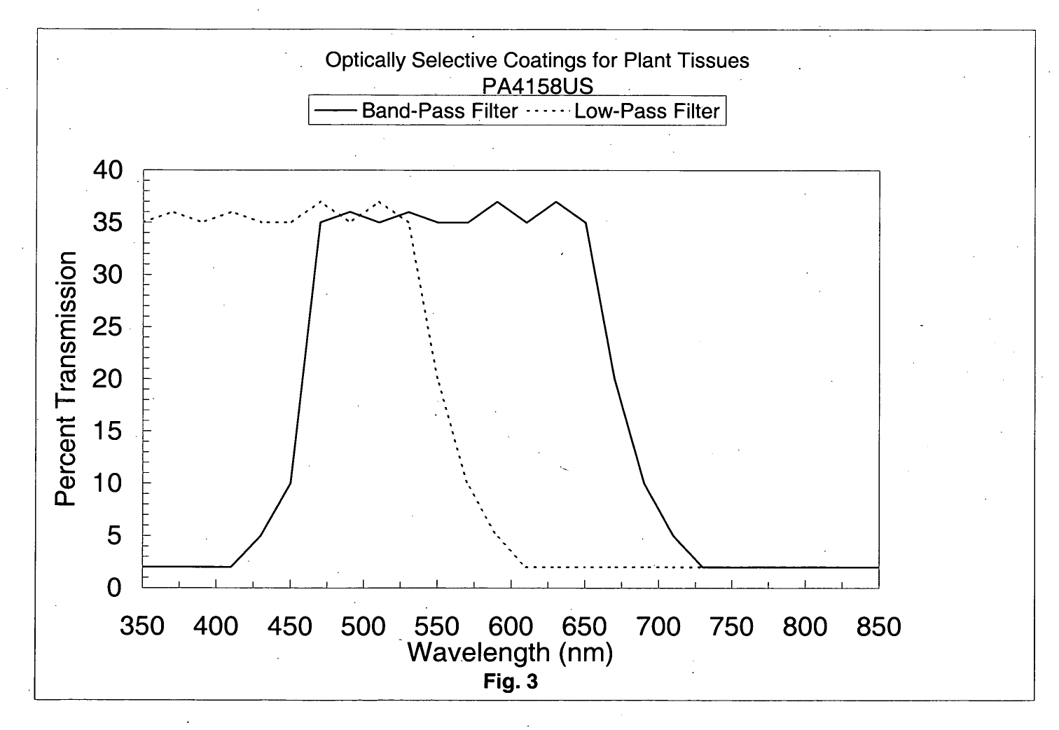

The present invention provides one or more optically selective chemical coatings for plant tissues. An “optically selective” coating is designed to transmit a desired, predictable spectrum of light. FIG. 3 shows exemplary transmission spectra for exemplary optically selective coatings. These examples are arbitrary, in that any desired transmission spectrum constructed by any means falls within the scope of the invention. For example, the coating can be designed to be a band-pass filter, i.e., a filter that transmits only one or more sets of contiguous wavelengths, such as a filter that transmits very little infrared and ultraviolet light while transmitting a large percentage of incident visible light, as indicated by the solid-line plot. In another embodiment, the optically selective coating may serve as a low-pass filter, allowing light of low wavelengths to pass through, while absorbing, scattering, or otherwise inhibiting the passage of higher-wavelength light. As shown by the dotted-line plot, a low-pass filter preferentially filters out long-wavelength infrared light while allowing shorter wavelengths to reach coated plant tissues.

Such filtering characteristics can be accomplished in multiple ways. For example, since very small particle size is predictably correlated with the ability to scatter light of a given wavelength (e.g., through Rayleigh scattering), a low-pass coating may be obtained by combining particles that preferentially scatter long-wavelength radiation with particles of other sizes, such as those that simply block radiation fairly evenly across all wavelengths. In another example, reduction of transmitted long-wavelength light can also be obtained with a food-grade dye, which preferentially absorbs radiation of a known wavelength or wavelength range.

In further examples, the desired filtering characteristics of a coating arise from its composition and/or thickness, which provide customized absorption or diffraction of light in desired wavelength ranges. In some embodiments, the coating comprises a thin-film coating in which the coating material is arranged in at least one layer that transmits certain wavelengths preferentially, while suppressing other wavelengths. For example, using diffraction grating calculations for a given composition, the thickness of a film that protects coated plant tissues by preferentially scattering away harmful radiation can be determined. Based on this information, one or more nontoxic surfactants may be added to the coating to achieve this desired thickness of the coating when it is applied to the plant tissues. In an alternative embodiment, the coating comprises an optically selective liquid crystal film.

The particles used may be any food-grade, commercially available nanobeads, crystals, or any other particles of the appropriate sizes. For example, calcium carbonate is routinely milled to a range of sizes, from chunks of rock used in landscaping to powder used to coat chewing gum, or finer. Using standard techniques, such as milling, homogenization and fractionation, microscopic particles of a desired size that scatter light of a particular wavelength or wavelength-range may be obtained. In some embodiments, various amounts of different sizes of light-scattering particles are combined in an optically selective coating.

The provided optically selective coating can be optimized for the plant tissue to be coated, and for the location of use. The wavelengths most beneficial or harmful to a given plant tissue can be determined using observations of the responses of the plant tissues to various radiation conditions, and/or by standard optical methods, including reflectance, transmission and/or absorption spectroscopy. For example, plants growing in more southern latitudes receive more watts of solar radiation per unit of surface area overall, as well as much more ultraviolet light relative to other wavelengths. Some embodiments of the present invention offer one or more optically selective coatings comprising a profile of particle sizes and densities to reduce transmission across all wavelengths, and especially at ultraviolet wavelengths, for such an application. Such a coating may be called a high-pass filter, since it allows light with high (or long) wavelengths to pass.

Using the provided invention, a tailored optically selective coating can be obtained for any application. For example, for commercial apple growers, a coating may be designed based on information including: the number of weeks since an initial bloom (on a scale of one to twenty-five weeks; as the number of weeks increases, apples become more susceptible to radiation burns); the latitude and altitude of the orchard (to account for variations in the wavelength spectrum of incident solar radiation); the variety of apples grown (e.g., Granny and Pink Lady apples are very susceptible to sunburn, while Galas are only moderately susceptible); measured exposure to ultraviolet, infrared, or other wavelengths of light; days from last application of radiation protection; and/or an Integrated Solar Management number (the lower the ISM, the more susceptible the product is to burn). Thus, the coating for Pink Lady apples may provide more protection from ultraviolet light than that for Gala apples. Of course, the same considerations apply to other plant tissues, and thus, for example, the coating produced for a variety of peppers growing in Central America will be distinct from that produced for peaches grown in Colorado. Any model, calculation, data, or combination of data, model and/or calculation may be used to inform the design of the one or more desired optically active coatings to optimize radiation protection and pass-through for any plant tissue.

Materials to be used in the optically selective coating can be optically characterized using standard methods, such as reflectance, transmission and/or absorption spectroscopy. Knowledge of the properties of incident radiation that are beneficial or harmful to plant tissues may be coupled with knowledge of the optical properties of prospective coating materials to produce optically selective coatings that are tailored to optimize the health of particular plant tissues according to some embodiments of the invention.

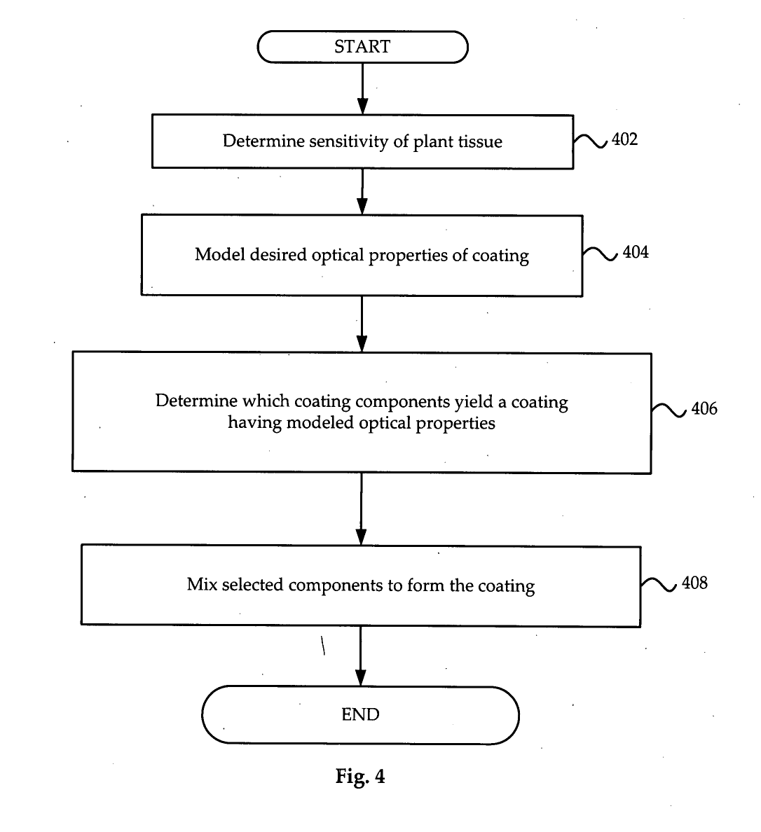

An exemplary embodiment of creating an optically selective coating is shown in FIG. 4, which is a flow chart of a method for producing an optically selective coating tailored for use on a particular plant tissue. At step 402, the optical sensitivity of a given plant tissue is determined. One way of making this determination would be to measure the optical properties of the plant tissue, such as reflectance and absorption, calculate any additional optical parameters (such as index of refraction), and use the measurements and calculations to decide which wavelengths are most beneficial and harmful to the plant tissue and therefore most desirable for the coating to transmit and block, respectively.

At step 404 commercially available computer software is used to model the desired optical properties. For example, using standard software packages, such as TFCalc, WVASE32, GSolver, Mathlab and/or MathCAD, a transmission curve may be calculated to match or closely approximate a desired transmission curve.

At step 406, commercially available computer software is used to determine which characteristics of a coating component in which proportions would yield a coating with optical properties closely approximating the desired, modeled optical properties. In other words, coating materials are selected based on their optical properties and parameters. The software packages are used to optimize the choice of coating materials to achieve the modeled, desired transmission curve based on material properties such as complex index of refraction, thickness of the coating, and proportions of materials to be combined to form the coating, for example, through the use of a Levenberg-Marquart regression analysis.

At step 408, components having characteristics indicated by the software are mixed into standard materials for coating plant tissues in proportions indicated by the software. For example, the output from the software packages may then be used to combine particles with the appropriate properties to compose a tailored film coating for providing optically selective protection to the chosen plant tissue.

In some embodiments, the optically selective coating is made by combining microscopic particles of an edible powder with standard solutions for application to plant tissues. For example, finely milled calcium carbonate that has been fractionated into batches according to the wavelength of light scattered, or according to size, may be used as individual fractions or a combination of fractions. For instance, to make an optically selective coating that is a band-pass filter that passes light in the wavelength range of 400-700 nanometers to the coated plant tissue while blocking other wavelengths of light, calcium carbonate particles from a fraction that scatters light of less than 400 nanometer wavelength are combined with particles from a fraction that scatters light of greater than 700 nanometer wavelength in a solution for application to plant tissues.

In an exemplary embodiment, the optically selective coating is made by combining optically active components, such as spheres, beads, crystals or other particles, and/or dyes or other chemical compounds having desired spectral characteristics, measuring the transmission spectrum of the combination, and adjusting the transmission spectrum by adjusting the recipe of the coating.

In some embodiments, the coating may be provided to the grower with separately packaged components that may be combined with the coating according to one or more provided recipes so that the grower may further tune the optically selective characteristics of the coating.

In an exemplary embodiment, data measured at or near the growth site of plant tissues to be coated is communicated to the site of design, making and/or shipping of the optically selective coating, and the coating is then sent to the growth site for application. Any method of growth site monitoring and/or communication is within the scope of the provided invention.

While various embodiments have been described above, it should be understood that they have been presented by way of example only, and not limitation. For example, any other set of endonuclease reaction components that achieves the provided method may be used. Thus, the breadth and scope of a preferred embodiment should not be limited by any of the above-described exemplary embodiments.

What is claimed is:

1. A method for making an optically selective coating for plant tissues, the method comprising:
determining the optical properties desired in a coating; and
combining one or more types of particles or chemical compounds having known optical properties with a known coating material having measurable optical properties, to obtain a coating having the desired optical properties.

2. The method of claim 1, wherein combining is determined by a regression analysis fitting the known and measurable optical properties to the desired optical properties.

3. The method of claim 1, further comprising:
modeling the desired optical properties;
determining which characteristics of a coating component in which proportions would yield a coating with optical properties closely approximating the desired, modeled optical properties; and
including components having characteristics indicated by the modeling in proportions indicated by the modeling in the coating.

4. The method of claim 2, wherein a transmission spectrum is a desired optical property.

5. The method of claim 3, wherein a coating component comprises particles.

6. The method of claim 4, wherein size is a characteristic of a coating component particle.

7. A method for protecting plant tissues from radiation with an optically selective coating, the method comprising:
preparing a coating for plant tissues using a material with at least one known particle size;
measuring the particle size distribution of the coating;
measuring at least one optical parameter of the coating at two or more wavelengths;
calculating theoretical values of the optical parameter at two or more wavelengths;
optimizing one or more of the optical parameters until one or more theoretical values of the parameters are a close match to the measured values;
determining desired values of the one or more optical parameters of the coating;
calculating a particle size distribution that yields a close match to the desired values for the one or more optical parameters;
manufacturing a coating having the calculated particle size distribution and desired one or more optical parameters; and
applying the coating to a plant tissue.

8. The method of claim 6, wherein the one or more optical parameters comprise a transmission spectrum.

9. The method of claim 6, wherein the one or more optical parameters comprise an absorption spectrum.

10. The method of claim 6, wherein the one or more optical parameters comprise a refractive index.

11. The method of claim 6, wherein the one or more optical parameters comprise a particle shape.

12. The method of claim 6, wherein the step of optimizing comprises using a regression analysis.

13. The method of claim 6, wherein the step of determining comprises measuring the wavelength-dependent sensitivity of the plant tissues to radiation damage.

14. The method of claim 6, wherein the step of determining comprises noting the geographical location of the plant tissues during exposure to sunlight.

15. The method of claim 6, wherein the step of determining comprises noting the time of year during which the plant tissues are exposed to sunlight.

16. A method for using an optically selective coating for plant tissues, the method comprising:
obtaining information about the response to radiation of a given plant tissue;
designing a desired transmission spectrum for the coating of the plant tissue;
making the coating from one or more particles and/or chemical compounds with known optical characteristics; and
applying the coating to the plant tissue.

17. The method of claim 15, the method further comprising:
designing an application schedule for coating the plant tissue, wherein applying the coating to the plant tissue is performed according to the application schedule.

18. The method of claim 15, wherein the step of designing comprises measuring incident wavelengths of sunlight as a function of time at the location of the plant tissue.

19. The method of claim 15, the method further comprising:
creating a database by measuring the optical properties of a variety of components that may be included in the coating.

20. The method of claim 19, wherein the step of making comprises using information from the database to determine the ingredients of the coating.

21. A method for using an optically selective coating for plant tissues, the method comprising:
obtaining information about the response to radiation of a given plant tissue;
designing a desired transmission spectrum for the coating of the plant tissue;
making the coating from one or more particles and/or chemical compounds with known optical characteristics;
designing an application schedule for coating the plant tissue; and
applying the coating to the plant tissue according to the application schedule.

22. A method for using an optically selective coating for plant tissues, the method comprising:
designing an application schedule for coating the plant tissue with an optically selective coating; and
applying the coating to the plant tissue according to the application schedule.

23. The method of claim 22, where the coating is a band-pass filter for wavelengths of electromagnetic radiation.

24. The method of claim 22, where the coating is a low-pass filter for wavelengths of electromagnetic radiation.

25. The method of claim 22, where the coating is a high-pass filter for wavelengths of electromagnetic radiation.

26. A method for selectively protecting plant tissues from electromagnetic radiation, the method comprising:
designing an application schedule for coating the plant tissue with an optically selective coating; and
applying the coating to the plant tissue according to the application schedule.

27. The method of claim 26, where the coating is a band-pass filter for wavelengths of electromagnetic radiation.

28. The method of claim 26, where the coating is a low-pass filter for wavelengths of electromagnetic radiation.

29. The method of claim 26, where the coating is a high-pass filter for wavelengths of electromagnetic radiation.

30. A class of materials comprising an optically selective coating for plant tissues, comprising a first material having known optical properties, and a second material that promotes application and adhesion to plant tissues.

31. The class of materials of claim 30, wherein the first and second materials are identical.

32. The class of materials of claim 30, wherein the first materials form a diffraction grating.

33. The class of materials of claim 30, wherein the first materials form a liquid crystalline film.

34. The class of materials of claim 30, further comprising a water repellant film or sealant.

35. The class of materials of claim 34, wherein the film or sealant is a wax.

36. A class of materials for coating plant tissues, the materials comprising a distribution of particles having sizes less than one micrometer, wherein the particle size distribution is tailored to have one or more preselected optical characteristics.

37. The class of materials of claim 36, wherein the optical characteristic is a transmission spectrum.

38. The class of materials of claim 37, wherein the transmission spectrum is a band-pass filter for wavelengths of electromagnetic radiation.

39. The class of materials of claim 37, wherein the transmission spectrum is a low-pass filter for wavelengths of electromagnetic radiation.

40. The class of materials of claim 37, wherein the transmission spectrum is a high-pass filter for wavelengths of electromagnetic radiation.

41. A class of materials for coating plant tissues, the materials comprising film-forming components, wherein the film thickness is tailored to have one or more preselected optical characteristics.

42. The class of materials of claim 41, wherein the optical characteristic is a transmission spectrum.

43. The class of materials of claim 41, wherein the optical characteristic is a diffraction grating.

44. The class of materials of claim 41, wherein the optical characteristic is a light-scattering profile.
